(19) United States
(12) Patent Application Publication
(10) Pub. No.: US 2025/0017193 A1
(43) Pub. Date: Jan. 16, 2025

(54) Animal Trap

(71) Applicant: Shenzhen Visson Technology Co., Ltd., Shenzhen (CN)

(72) Inventor: Guoqing Hu, Shenzhen (CN)

(73) Assignee: Shenzhen Visson Technology Co., Ltd., Shenzhen (CN)

(21) Appl. No.: 18/350,962

(22) Filed: Jul. 12, 2023

(51) Int. Cl. A01M 23/02

(52) U.S. Cl. CPC A01M 23/02

(57) ABSTRACT

The present invention provides an animal trap, which comprises a base, a shell, a trigger mechanism and a lure device arranged in the shell, wherein the shell is provided with at least one closable open end, which defines a passage for animals to enter or leave a space, and at least one door capable of opening or closing the open end; the trigger mechanism comprises a pedal and at least one driving arm extending away from the upper surface, and the driving arm has a driving end; the trigger mechanism is configured to trigger the door to close the passage when the animal enters the space through the open end.

### TECHNICAL FIELD

The present invention relates to the technical field of animal trapping, in particular to an animal trap.

### BACKGROUND

In order to deal with the harm caused by rats, people have developed many methods to drive rats, such as rat poison, ultrasonic rat repellent or rat trap. Among these methods, rat poison is easy to pollute the environment and be eaten by pets or children. Due to high security risks, ultrasonic rat repellent is widely used in outdoor scenes such as gardens, and when used indoors, its high use cost will bring economic burden to ordinary families. Therefore, the rat trap is widely used in daily life because of its cheaper use cost.

However, in the prior art, the structures of rat traps are complicated, such as U.S. Pat. Nos. 9,420,777, 9,661,839 and 10,058,088. The trigger mechanism of the above-mentioned rat traps is complicated, and it needs the cooperation and linkage of multiple parts to catch rats entering the cages, and the trigger mechanism is bulky, so the success rate of catching rats with large volume is low, and at the same time there is a certain failure probability of the trigger mechanism.

Based on the above problems, it is necessary to put forward a brand-new capture device to capture mice or other animals that users need to capture. The trigger mechanism of the capture device is simple in structure, with low failure rate, and at the same time, it has a small component volume. Under the condition that the shell size of the capture device is the same, the brand-new capture device can capture mice or other animals with larger volume.

### SUMMARY

The present invention provides an animal trap, which includes a base, a shell, a trigger mechanism and a lure device arranged inside the shell, wherein,
the shell is detachably attached above the base and is provided with at least one closable open end, wherein the shell defines at least one space for accommodating animal activities, the open end defines a passage for animals to enter or leave the space, the open end further comprises at least one door capable of opening or closing the open end, and the door has a first position and a second position for opening and closing the open end;
the trigger mechanism comprises a pedal which is rotatably pivoted into the shell, the pedal is provided with an upper surface, and at least one driving arm extending away from the upper surface is also arranged on the pedal, and the driving arm has a driving end; the trigger mechanism is configured to trigger the door to close the passage when an animal enters the space through the open end;
when the door is in the first position of opening the open end, the driving end abuts on an outer edge of the door; when an animal is induced by the lure device and enters the space through the open end, the driving end is far away from the door.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic view of an animal trap door in a first position provided by the present invention;

FIG. 2 is a schematic view of the door of an animal trap provided by the present invention in a second position;

FIG. 3 is another schematic view of FIG. 1;

FIG. 4 is a sectional view of FIG. 1;

FIG. 5 is a schematic view of FIG. 1 (without the shell and the second door body);

FIG. 6 is an enlarged schematic view at A in FIG. 5;

FIG. 7 is a sectional view of the shell.

In the drawings:
100, Base; 200 Shell; 211, First open end; 212, Second open end; 213, First pivot hole; 214, First limiting part; 215, Second pivot hole; 221, Space; 241, First door body; 242, Second door body; 243, First rotating shaft; 244, Guide groove; 250, Second limiting part; 260, Torsion spring; 270, Observation window; 300, Trigger mechanism; 310, Pedal; 311, Upper surface; 313, Second rotating shaft; 320, Driving arm; 321, Driving end; 330, Elastic part; 340, Receiving seat; 400, Lure device; 410, Slot; 500, Vent hole.

### DESCRIPTION OF EMBODIMENTS

In the following, the technical scheme in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

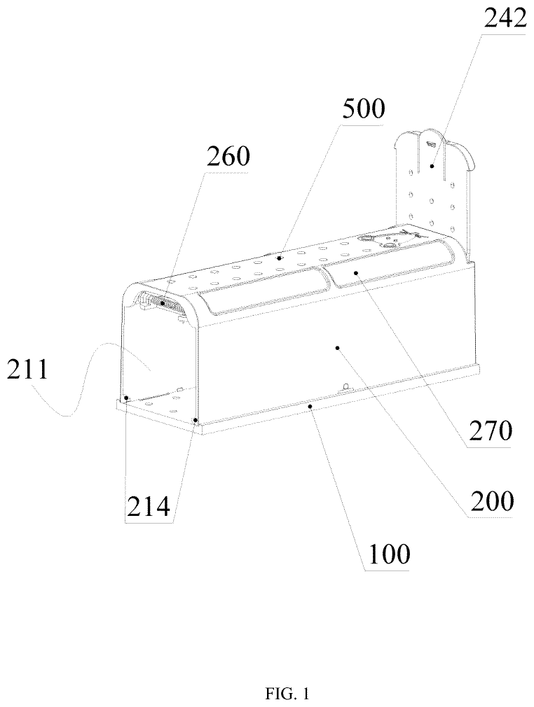

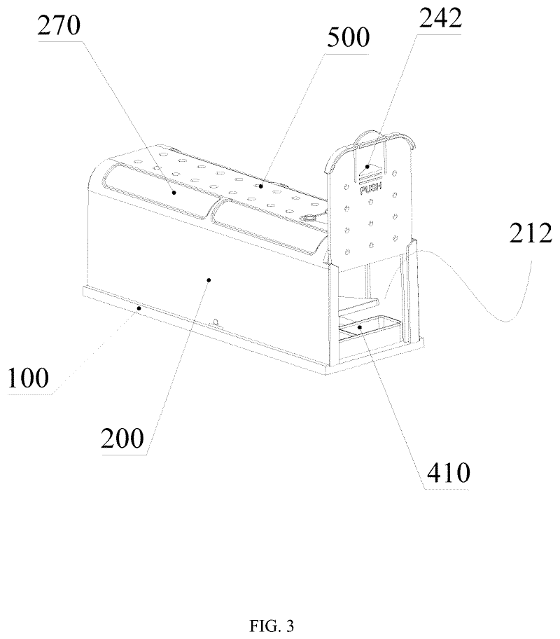

As shown in FIGS. 1 to 6, an animal trap provided by the present invention includes a base 100, a shell 200, a trigger mechanism 300, and a lure device 400 arranged inside the shell 200.

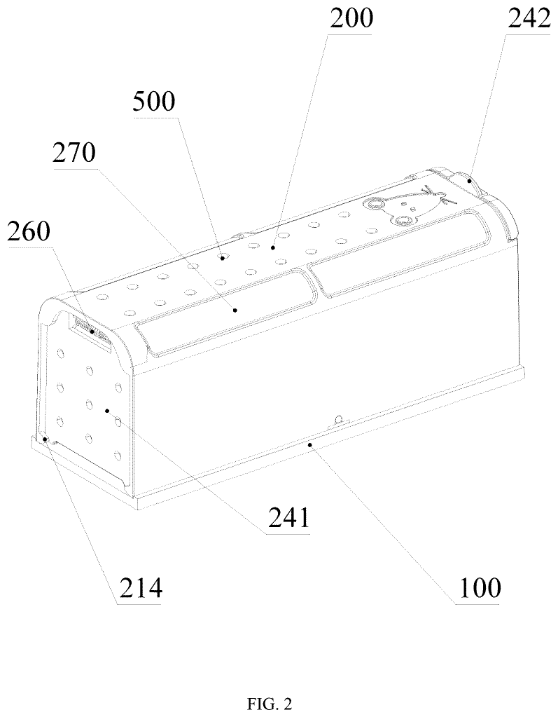

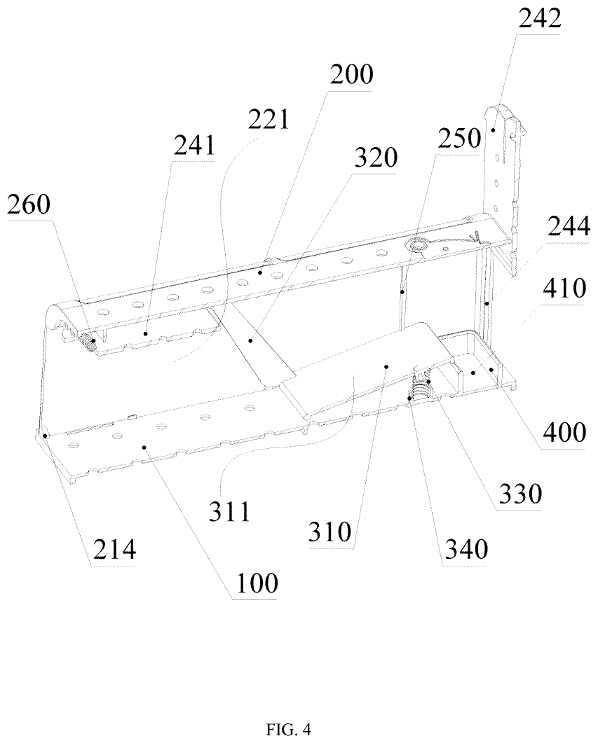

As shown in FIGS. 1 and 4, the shell 200 is detachably attached to the top of the base 100, and is provided with at least one closable open end. The shell 200 defines at least one space 221 that can accommodate animals' activities, and the open end defines a passage for animals to enter or leave the space 221. The open end also includes at least one door that can open or close the open end, and the door has a first position (see FIG. 1) and a second position (see FIG. 2)

In this embodiment, the shell 200 is detachably attached onto the base 100 in a snap mode. In other embodiments, the connection mode can also be a screw thread or other detachable connection mode, which is convenient for users to clean the trap.

As shown in FIGS. 1 to 4, the shell 200 is provided with a first open end 211 and a second open end 212, and the door includes a first door body 241 and a second door body 242, wherein the first door body 241 is rotatably pivoted into the first open end 211, and the second open end 242 is provided with a guide groove 244, and the second door body 242 is inserted into the guide groove 244, wherein the first open end 211 defines a passage for animals to enter the space 221, and the second open end 242 defines a passage for animals to leave the space 221.

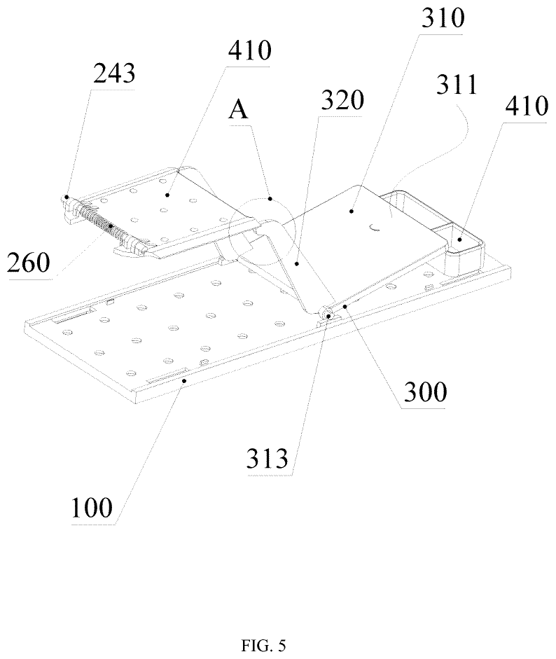

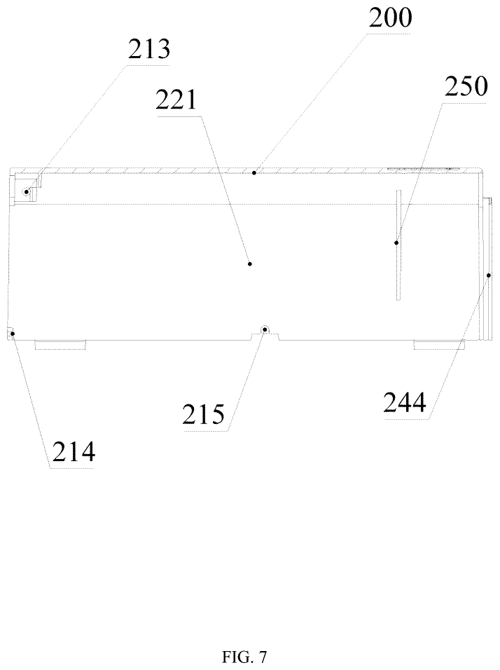

Specifically, as shown in FIGS. 5 to 7, the upper edge of the first open end 211 is provided with a first pivot hole 213, and the upper edge of the first door body 241 is formed with a first rotating shaft 243, which is arranged in the first pivot hole 213, so that the first door body 241 is rotatably pivoted into the first open end 211. At this time, the first door body 241 tends to rotate downward relative to the first open end 211, closing the first open end 211. In order to shorten the capture time and improve the capture success rate, as a preferred embodiment of the present invention, the rotating shaft 243 is also provided with a torsion spring 260, which exerts elastic force on the first door body 241, so that the potential energy of the first door body 241 closing the first open end 211 is greater and the closing time is shorter, which greatly improves the success rate of capture. In order to prevent the first door body 241 from turning out of the first open end 211, the first open end 211 is also provided with a first limiting part 214 (see FIG. 4). When the first door body 241 is in the second position, the first door body 241 abuts against the first limiting part 214, which effectively prevents the mouse from escaping.

When the animal needs to be lifted out of the trap, the second open end 212 can be opened by lifting the second door body 242 upward, and the trapped animal can leave the space 211 from the second open end 212.

In some embodiments (not shown in the figure), the torsion spring 260 can also be other forms of elastic parts. In other embodiments (not shown in the figure), magnetic parts can also be arranged on the first door body 241 and the first open end 211, and the closing efficiency of the first door body 241 relative to the first open end 211 can be increased by magnetism. In other embodiments (not shown in the figure), the torsion spring 260 or other forms of elastic parts can also be provided on the first door body 241 or the first open end 211.

As shown in FIGS. 5 to 7, the trigger mechanism 300 of the present invention includes a pedal 310 rotatably pivoted into the shell 200, the pedal 310 has an upper surface 311, and the pedal 310 is also provided with at least one driving arm 320 extending away from the upper surface 311, and the driving arm 320 has a driving end 321; the trigger mechanism 300 is configured to trigger the door to close the passage when an animal enters the space 221 through the open end.

When the door is in the first position to open the open end, the driving end 321 abuts against the outer edge of the door; when an animal is induced by the lure device 400 and enters the space 221 through the open end, the driving end 321 is far away from the door.

Specifically, as shown in FIGS. 5 to 7, a second pivot hole 215 is arranged in the shell 200, and a second rotating shaft 313 is formed on the pedal 310, and the second rotating shaft 313 is arranged in the second pivot hole 215, wherein the second pivot hole 215 has a certain longitudinal height from the base 100, so that the pedal 310 has a high position and a low position when rotating.

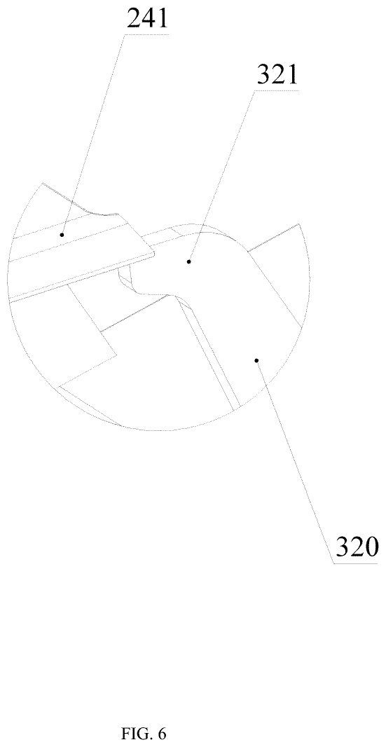

As a preferred embodiment of the present invention, as shown in FIG. 6, the driving end 321 has a cam surface. When the first door body 241 is in the first position to open the first open end 211, the outer edge of the first door body 241 abuts against the cam surface of the driving end 321, and the extension length of the driving arm 320 is greater than the length of the pedal 310.

In this embodiment, when an animal enters the space 211 and reaches the pedal 310, the weight of the animal can make the pedal 310 rotate from a higher position to a lower position. At this time, the driving arm 320 on the pedal 310 will also rotate together. During the rotation of the driving arm 320, the driving end 321 with a cam surface will move from a lower position to a higher position by the lever principle. The cam surface of the driving end 321 will leave the outer edge of the first door body 241, so that the driving end 321 and the first door body 241 are separated from each other. The first door body 241 uses the torsion spring 260 to quickly close the first opening end 211, and finally the animals entering the space 211 are confined therein.

In this embodiment, the cam surface of the driving end 321 can make the process of the driving end 321 moving away from the first door body 241 and the process of the first door body 241 returning from the first position to the second position smoother; the extension length of the driving arm 320 is longer than the length of the pedal 310, which can prevent the first door body 241 from being triggered to close when the larger mouse or animal does not completely enter the space 211, effectively preventing the mouse from escaping or clamping the tail of the mouse, so that the trap can capture the larger mouse or animal. In some embodiments, the outer edge of the first door body 241 can be polished to further avoid pinching the tail of a mouse.

As shown in FIG. 4, in order to facilitate the repeated and efficient use of the animal trap, the base 100 is provided with an elastic part 330, and the pedal 310 also has a lower surface, and the elastic part 330 abuts against the lower surface of the pedal 310.

Specifically, the base 100 also includes a receiving seat 340, and the elastic part 330 is arranged in the receiving seat 340. When the trapped mouse leaves the pedal 310, the elastic part 330 can quickly drive the pedal 310 from a low position to a high position, and then return to the use state.

As shown in FIG. 4, in order to prevent the pedal 310 from continuing to rotate in the process of returning to the use state, the shell 200 is also provided with a second limiting part 250, which can limit the pedal 310 from continuing to rotate in the process of rotating from a low position to a high position, and then deviate from the use state. Specifically, when the outer edge of the first door body 241 abuts against the cam surface of the driving end 321, the upper surface 311 of the pedal 310 abuts against the second limiting part 250.

As a preferred embodiment of the present invention, as shown in FIG. 5, the seduction device 400 includes at least one slot 410 that can accommodate food. The slot 410 is detachably attached to the inside of the shell 200 and is arranged at the second open end 242. Specifically, in this embodiment, there are two slots 410 for placing food and water respectively, which can be replaced or added through the second open end 242. The slots 410 in which the tempting food is placed can effectively lure the mouse into the space 211 and reach the pedal 310, thus triggering the work of the trigger mechanism 300.

In some embodiments (not shown in the figure), in order to adapt to the scene without food or water, or to capture specific animals, the lure device 400 can also be a loudspeaker, which can play the sound of luring animals into the space 221 to trap mice or animals through the sound.

It can be understood that the trapping object of the animal trap provided by the present invention is not only aimed at mice, but also rabbits or other rodents. When the size of the animal trap is larger, it can also trap large animals such as dogs, cats or elephants, and users can choose the corresponding animal trap according to the actual use requirements.

In order to avoid suffocation of trapped animals in the space 211, as shown in FIGS. 1 to 7, the base 100, the shell 200 and the door are all provided with a plurality of vent holes 500, which can make the air in the space 211 circulate. Further, as shown in the figure, the shell 200 is also provided with an observation window 270, through which the user can observe the condition of animals in the trap.

Compared with the prior art, the trigger mechanism of the animal trap has the advantages of simple structure, low failure rate and smaller component volume, and the animal trap can catch larger mice or other animals under the condition that the shell size of the trap is the same.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. An animal trap, comprising a base, a shell, a trigger mechanism and a lure device arranged inside the shell, wherein,
the shell is detachably attached above the base and is provided with at least one closable open end, wherein the shell defines at least one space for accommodating animal activities, the open end defines a passage for animals to enter or leave the space, the open end further comprises at least one door capable of opening or closing the open end, and the door has a first position and a second position for opening and closing the open end;
the trigger mechanism comprises a pedal which is rotatably pivoted into the shell, the pedal is provided with an upper surface, and at least one driving arm extending away from the upper surface is also arranged on the pedal, and the driving arm has a driving end; the trigger mechanism is configured to trigger the door to close the passage when an animal enters the space through the open end;
wherein, when the door is in the first position of opening the open end, the driving end abuts on an outer edge of the door; when an animal is induced by the lure device and enters the space through the open end, the driving end is far away from the door.

2. The animal trap according to claim 1, wherein the shell is provided with a first open end and a second open end, and the door comprises a first door body and a second door body.

3. The animal trap according to claim 2, wherein the first door body is rotatably pivoted into the first open end, the second open end is provided with a guide groove, and the second door body is inserted into the guide groove, wherein the first open end defines a passage for animals to enter the space, and the second open end defines a passage for animals to leave the space.

4. The animal trap according to claim 3, wherein the lure device comprises at least one slot for accommodating food, and the slot is detachably attached to the inside of the shell and is arranged at the second open end.

5. The animal trap according to claim 4, wherein the driving end has a cam surface, and when the first door body is in the first position of opening the first opening end, the outer edge of the first door body abuts against the cam surface of the driving end.

6. The animal trap according to claim 5, wherein an extension length of the driving arm is greater than a length of the pedal.

7. The animal trap according to claim 6, wherein the base is provided with an elastic piece, and the pedal also has a lower surface, and the elastic piece abuts against the lower surface of the pedal.

8. The animal trap according to claim 7, wherein a limiting part is further arranged inside the shell, and when the outer edge of the first door body abuts against the cam surface of the driving end, the upper surface of the pedal abuts against the limiting part.

9. The animal trap according to claim 1, wherein the base, the shell and the door are all provided with a plurality of vent holes, and the plurality of vent holes can circulate the air in the space.

10. The animal trap according to claim 1, wherein the lure device comprises a loudspeaker, and the loudspeaker can play the sound of luring animals into the space.
